(19) United States
(12) Patent Application Publication
(10) Pub. No.: US 2018/0118075 A1
(43) Pub. Date: May 3, 2018

(54) Adjustable Cup Holder Adapter

(71) Applicant: Michael Schultz, Muray, UT (US)

(72) Inventor: Michael Schultz, Muray, UT (US)

(21) Appl. No.: 15/338,315

(22) Filed: Oct. 28, 2016

(51) Int. Cl. B60N 3/10

(52) U.S. Cl. CPC B60N 3/103; B60N 3/105

(57) ABSTRACT

A cup holder adapter for a beverage container comprising a container holder formed from a sturdy, resistant material, wherein cylindrical adapters can be attached to fit in a vehicle cup holder of various sizes.

### FIELD OF THE INVENTION

The present disclosure relates to a sturdy, adjustable cup holder adapter for cups and bottles of sizes that are generally larger than what most cup holders can accommodate. More specifically, the present disclosure describes an adjustable cup holder adapter to allow beverage containers of various sizes to fit in car cup holders.

### BACKGROUND

Many people like to drink a beverage such as water while traveling in a vehicle. Some vehicles, including many automobiles, feature cup holders that are integrated with the vehicle's interior to hold in place a beverage container such as a cup, mug, or bottle. Built-in cup holders can be placed near a driver or passenger as a means to provide a convenient place to hold a beverage container when not in use. For example, many automobiles have built-in cup holders, which allow drivers and their passengers to secure their beverage containers when not in use. Built-in cup holders prevent beverage containers from tipping over and spilling their contents on the driver, passengers, and the car.

However, conventional built-in cup holders are limited in several ways. First, conventional built-in cup holders accommodate only a single standard size beverage container, preventing use with non-standard beverage containers. Second, standard vehicle cup holders are unsuitable for use with larger beverage containers. For example, standard water bottles exceed the diameter of many conventional built-in cup holders.

Conventional cup holders are limited to fit beverage containers of specific sizes. While there are cups, mugs, and bottles of many different sizes, conventional cup holders are intended solely to hold containers of a standard size. Anything larger than the standard size beverage container will not fit and renders the cup holder useless. Even though a cup or bottle may be smaller than a conventional built-in cup holder and be able to sit inside it, unless there is a tight enough fit to hold the container in place, the container will easily tip over and spill its contents.

Furthermore, conventional cup holders are not intended for water bottles. The one size nature of conventional cup holders will not permit them to accommodate popular water bottles which are generally wider than standard beverage containers. The one-size-fits-all nature of conventional cup holders requires a specific cup holder for each and every kind of water bottle.

### DESCRIPTION OF THE RELATED ART

To overcome some of these problems, conventional cup holder adapters can be used with cup holders to help accommodate larger beverage. However, a problem of conventional cup holder adapters is that they are limited to fit one size of cup holder. Car manufacturers do not rely on a standard size of cup holder, but instead each use a cup holder of one size. Conventional cup holder adapters are limited to fit a pre-determined size of a cup holder and cannot be adjusted to cup holders of other sizes. While an adapter may fit when inserted into one kind of built-in cup holder, it may not fit securely enough to be of use to prevent a beverage container from tipping over. If the adapter cannot fit securely or tight enough in the built-in holder while holding a container, the container and adapter may still tip over and spill the beverage, rendering the adapter and the cup holder useless.

It is not easy to find a cup holder adapter that can readily fit a cup holder of a specific size. The drawbacks of conventional cup holders and adapters cause many to buy a specific cup holder adapter which may not fit a specific beverage container. Alternatively, many users have a cup holder or adapter that can only work with one size and shape of beverage container. If another beverage container is used, it may not work in the cup holder or with a conventional adapter.

Given the aforementioned drawbacks of conventional cup holders and adapters, it is one object of this disclosure to provide an adjustable cup holder adapter that accommodates beverage containers of variable sizes. It is another object of this disclosure to provide an adjustable cup holder adapter that is intended to secure the beverage container properly in place, adjusting for cup holders of variable sizes. It is another object of this disclosure to provide an adjustable cup holder adapter that can accommodate water bottles of variable size.

### BRIEF SUMMARY OF THE INVENTION

A cup holder adapter for a beverage container comprising a container holder formed from a sturdy, resistant material, wherein cylindrical adapters can be attached to fit in a vehicle cup holder.

Still other objects, features and advantages of the present invention are those inherent in or implied from the novel combination, structure, and arrangement of parts as best exemplified by the preferred embodiment of the invention hereinafter to be described, reference being had to the accompanying drawings wherein.

### BRIEF DESCRIPTION OF THE DRAWINGS

Referring particularly to the drawings for the purposes of illustration and not limitation:

FIG. 1: is a perspective view of an adjustable cup holder.

FIG. 2: is an exploded perspective view of an adjustable cup holder demonstrating the orientation of the several of its parts.

FIG. 3: is a perspective of a container holder.

FIG. 4: is a perspective view of a first base adapter.

FIG. 5: is a cross view of a first base adapter in unlocked position with a container holder.

FIG. 6: is a perspective view of a first base adapter in unlocked position with a container holder.

FIG. 7: is a cross view of a first base adapter in locked position with a container holder.

FIG. 8: is a perspective view of a first base adapter in unlocked position with a container holder.

FIG. 9 is a perspective view of an alternative embodiment of a container holder.

FIG. 10 is a partially exploded view of an alternative embodiment of an adjustable cup holder demonstrating the orientation of several of parts.

### DETAILED DESCRIPTION OF THE INVENTION

Turning now descriptively to the drawings, in which similar reference characters denote similar elements throughout the several views,

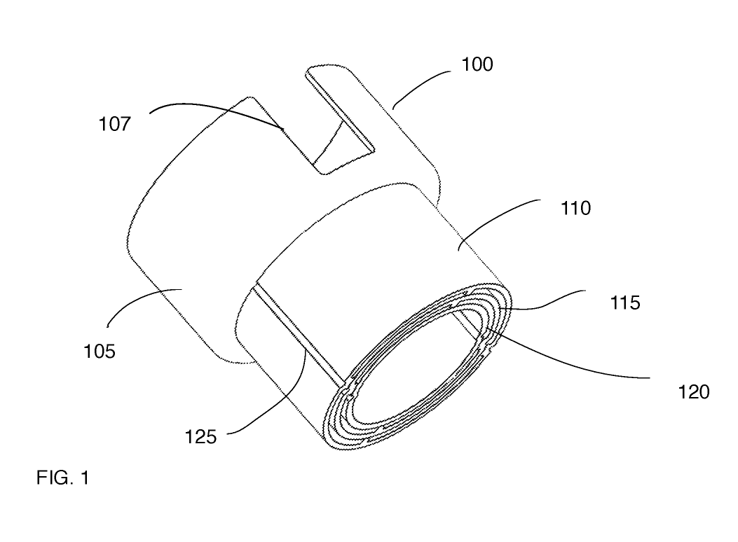

FIG. 1 is a perspective view of an adjustable cup holder 100 for a beverage container, which is adjustable for placement inside built-in cup holders, which are found in vehicles. An adjustable cup holder 100 is created using a sturdy and rigid material. Examples of materials that can be used include plastics, thermoplastics, metals, polymers, and any other sturdy and rigid material.

An adjustable cup holder 100 is formed primarily by the container receptacle 105, which is securely attached to a base insert 120. If a vehicle's built-in cup holder is wider than the base mount 120, then one or more base adapters can be removably attached to increase the adjustable cup holder adapter's width, thereby improving its fit inside the cup holder.

A container receptacle 105 is formed in a hollow, cylindrical fashion with an opening at the container receiving end and an opposing base end. Rigidly attached at the base end of a container receptacle 105, is a rigidly secured base insert 120. In one embodiment, a gap may be formed in the container receptacle 105 to accommodate a beverage container's handle. A base insert 120 is formed in a cylindrical fashion with a closed end secured at the base end of the container receptacle 105 and an opposing end.

In one embodiment, a second base adapter 110 and a first base adapter 115 are attached to the container holder. An attachable sleeve adapter such as the first base adapter 115 or a second base adapter 110, can be used in situations where a vehicle's built-in cup holder diameter is wider than a base insert 120 and will not provide a secure fit to prevent a beverage container from tipping and spilling. A first base adapter 115, or a second base adapter 110 in combination with a first base adapter 115, are sequentially slid onto the base insert 120 to attach and securely fit the adjustable cup holder adapter in a cup holder, thereby preventing a beverage container from tipping over.

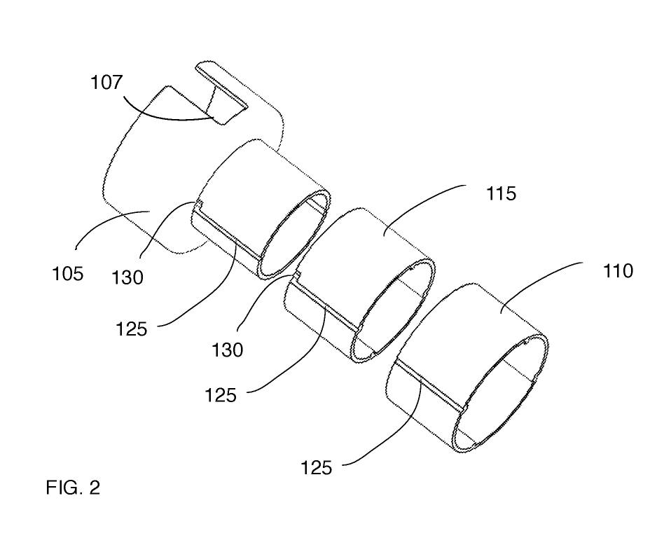

FIG. 2 is an exploded perspective view of an adjustable cup holder 100 for a cup or water bottle demonstrating the orientation of several of an adjustable cup holder adapter's parts. FIG. 2 shows the container receptacle 105, first base adapter 115, and second base adapter 100 are aligned to fit and lock in place when used in combination.

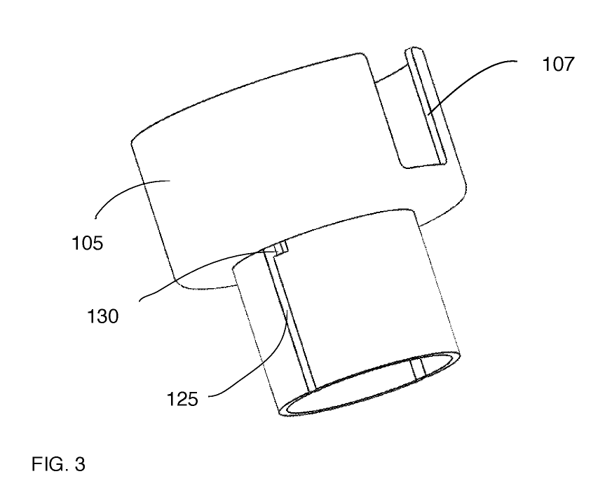

FIG. 3 is a perspective of the container receptacle 105 with a base insert 120 having a locking groove 125 and locking notch 130.

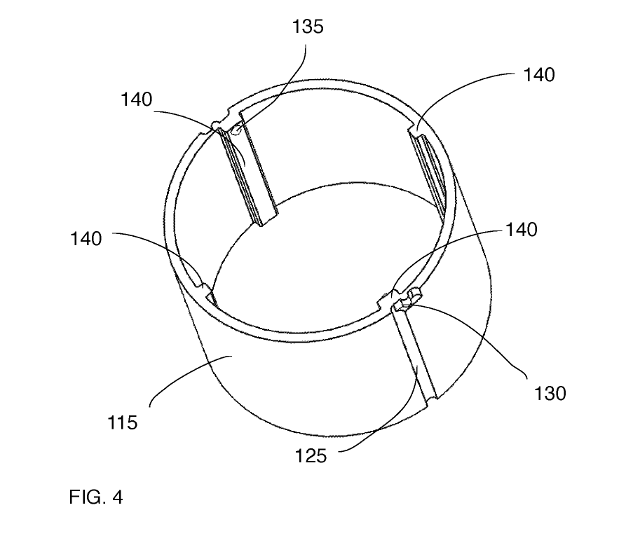

FIG. 4 is a perspective view of a first base adapter 115. This view is similar for the second base adapter 110. An adapter is a hollow cylinder modified with open top and bottom ends and one or more a locking grooves 125 extending longitudinally on the adapter's external surface with a locking notch 130 at one end. A first base adapter 115 also has one or more stabilizing ridges 140 extending longitudinally along the adapter's internal surface. A stabilizing ridge 140 has a locking nub 135 at the top end of the first base adapter 115. A first base adapter is longitudinally oriented with the container receptacle 105 with the locking nub 135 aligned with an opposing locking groove 125 of the container receptacle 105. Guided by the locking nub 135 sliding along the locking groove 125, the first base adapter 115 encompasses the container receptacle 105. Stabilizing ridges 140 also act to hold an adapter in place against another adapter sleeve or against the container receptacle 105.

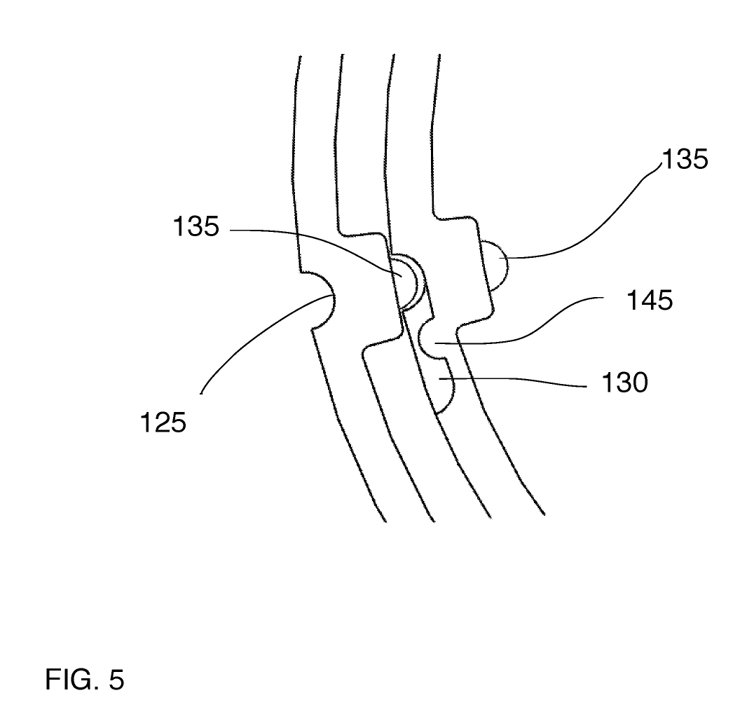

FIG. 5 is a cross view of a first base adapter 115 in unlocked orientation with a container receptacle 105. A first base adapter 115 can be attached to the container receptacle 105 to stabilize the adjustable cup holder 100 in larger cup holder holes. A first base adapter 115 is attached to the container receptacle 105 by orienting the two adapters in longitudinal fashion with a locking nub 135 positioned on an internal surface of the first base adapter 115 and aligned with a locking groove 125 of the container receptacle 105. The first base adapter slides upwards towards the opposite end of the adjustable cup holder 100. As a first base adapter 115 covers the container receptacle 105, a locking nub 135 stays within a locking groove 125 until the locking groove guides the locking nub 135 to a locking notch 135. In another embodiment, a second base adapter 110 or more base adapters are attached in a similar manner.

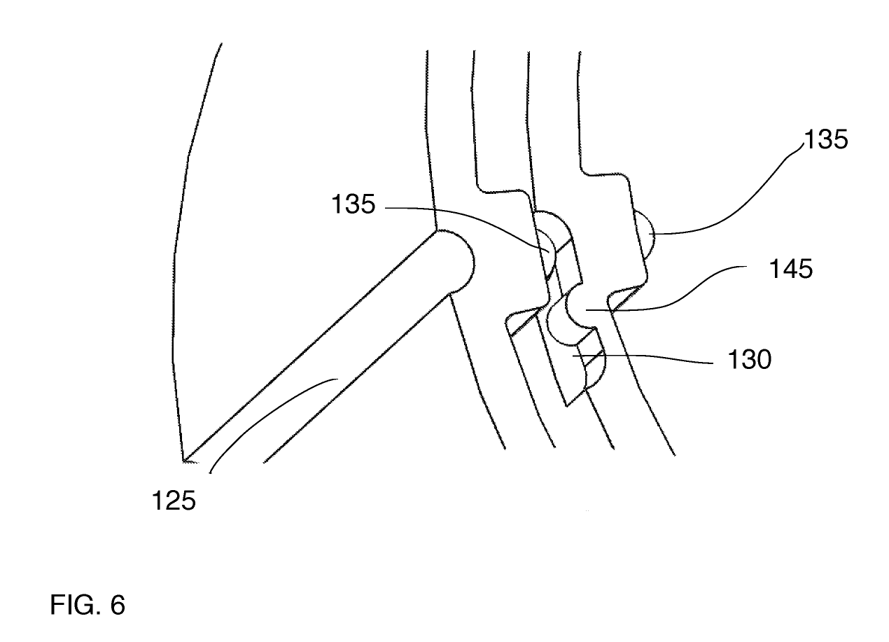

FIG. 6 is a perspective view of a first base adapter 115 in unlocked position with a container receptacle 105. In an unlocked position, the locking nub 135 can slide up and down the locking groove 125 when attaching or removing a base adapter sleeve. In an unlocked position, the locking nub 135 is not held in place the locking notch 130 by the locking ridge 145,

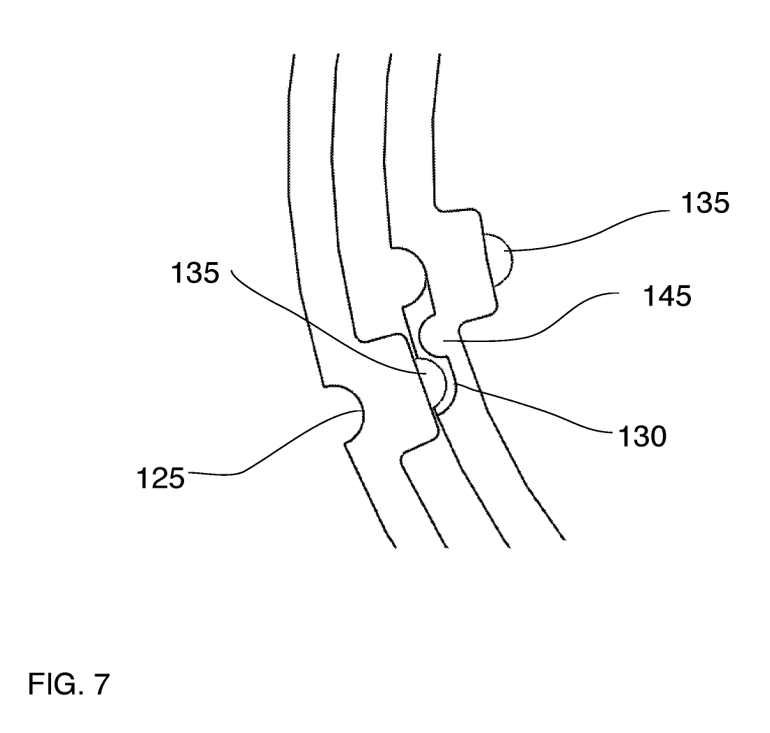

FIG. 7 is a cross-sectional view of a first base adapter 115, first introduced in FIG. 1, in locked position with a container receptacle 105 first introduced in FIG. 1. A first base adapter 115 is locked in position with a container receptacle 105 to stabilize the adjustable cup holder adapter 100 in larger cup holder holes. A first base adapter 115 is locked in position to the container receptacle 105 by twisting in a latitudinal manner the first base adapter 115 so that the locking nub 135 moves along the locking notch 130 and held in place by the locking ridge 145 and is secured in place. The first base adapter 115 is then held in place with container receptacle 105 until first base adapter 115 is twisted to move the locking nub 135 back over the locking ridge 145, unlocking the first base adapter 115. The first base adapter is then removed by sliding the adapter locking nub 135 out of the locking groove 125.

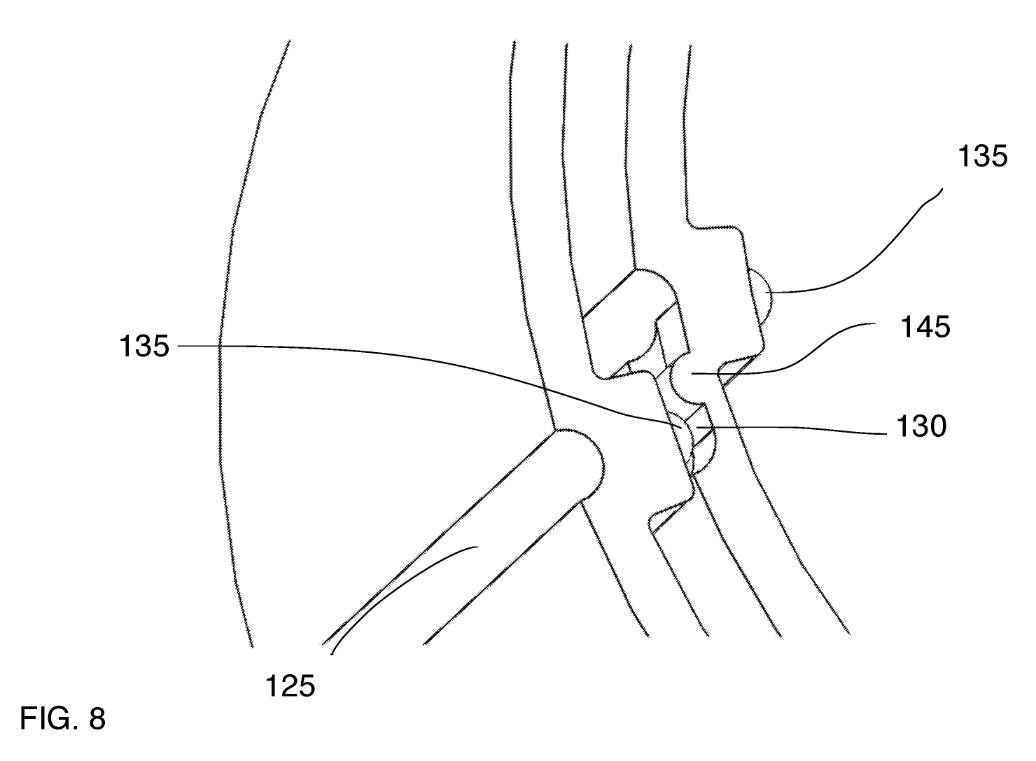

FIG. 8 is a perspective view of a first base adapter 115 in locked position with a container receptacle 105.

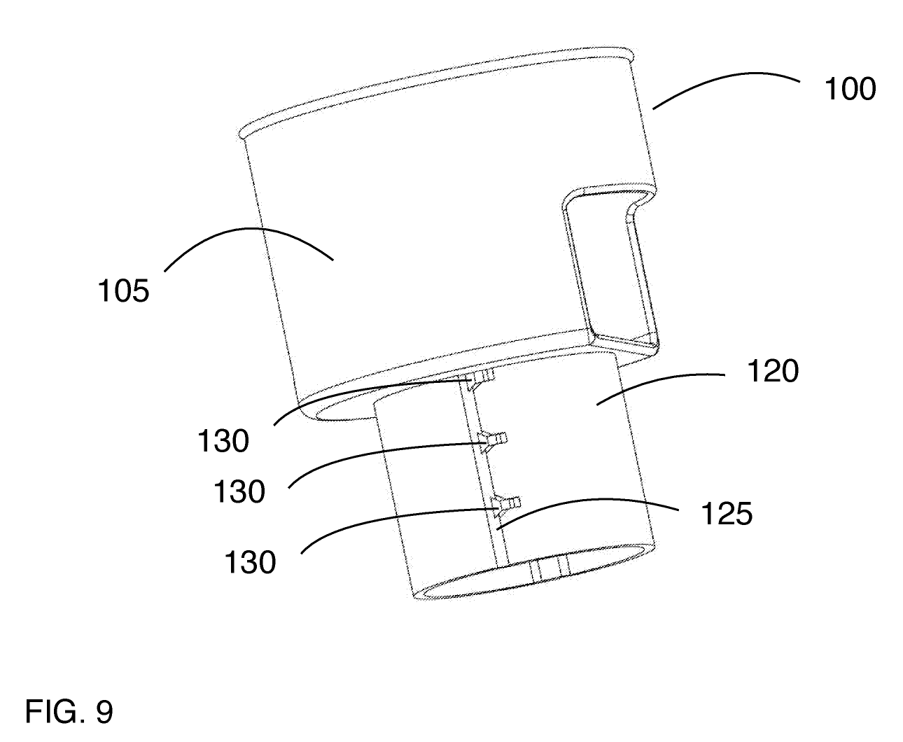

FIG. 9 is a perspective of an alternative embodiment of a container receptacle 105 holder rigidly attached to a base mount 120 with more than one locking notches 130 at various lengths along the locking groove 125 adjust the height of the adjustable cup holder adapter. More than one locking notches 130 at along a locking groove 125 allows a base adapter to be attached at variable lengths, giving the adjustable base cup adapter 100 variable heights. This allows the adjustable base cup adapter 100 to fit built-in cup holders of variable depths as well as widths.

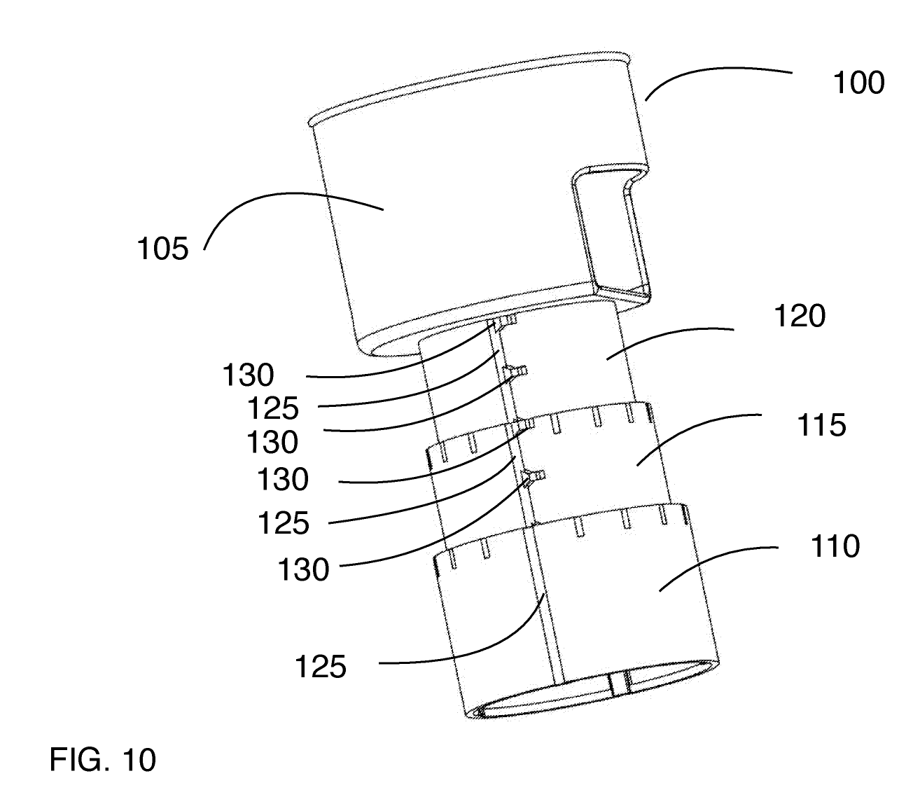

FIG. 10 is a perspective view of an alternative embodiment an adjustable cup holder 100 for a beverage container in a variable depth assembly. To provide an adjustable cup holder adapter of greater height, which is able to insert into built-in cup holders of greater depth, a first base adapter 115 slides along and locks at variable lengths along the base mount 120. A first base adapter 115 is attached to the container receptacle 105 by orienting the two adapters in longitudinal fashion with a locking nub 135 (not shown) positioned on an internal surface of the first base adapter 115 and aligned with a locking groove 125 of the container receptacle 105. The first base adapter slides upwards towards the opposite end of the adjustable cup holder 100 and is locked at the chosen locking notch 130. As a first base adapter 115 covers the container receptacle 105, a locking nub 135 stays within a locking groove 125 until the locking groove guides the locking nub 135 to a locking notch 130. A first base adapter 115 is rotated in a latitudinal manner to move a locking nub 135 across the locking notch 130 to where it secured in a locked position. In another embodiment, a second base adapter 110 or more base adapters are attached in a similar manner.

What is claimed is:

1. An adjustable cup holder adapter comprising:
a container receptacle securely attached to a base insert.

2. The adjustable cup holder adapter of claim 1, wherein the container receptacle includes an open container receiving end and a closed opposing base end wherein the container receptacle is formed in a hollow, cylindrical configuration.

3. The adjustable cup holder adapter of claim 1, wherein the base insert includes a closed end and an opposing end wherein the base insert is formed in a cylindrical configuration;

4. The adjustable cup holder adapter of claim 1, wherein the base insert includes at least a locking groove extending longitudinally along the insert's exterior surface and a locking notch where the base insert is attached to the container receptacle.

5. The adjustable cup holder adapter of claim 1, wherein the container receiving end of the container receptacle allows a container to be supported when inserted into the adjustable cup holder adapter.

6. The adjustable cup holder adapter of claim 1, wherein at least one base adapter includes an attaching end and an opposing end, removably attached to the base insert.

7. The adjustable cup holder adapter of claim 6, wherein the base adapter includes at least one locking groove extending longitudinally along the exterior surface of the adapter, at least one locking notch placed at the attaching end of the locking groove, and at least one locking nub placed at the attaching end of the locking groove.

8. The adjustable cup holder adapter of claim 6, wherein the insert adapter is removably attached to the base insert by longitudinally aligning the locking groove of the base insert with the locking nub of the base adapter allowing the insert adapter to securely attach to the base insert.

9. The adjustable cup holder adapter of claim 6, wherein the insert adapter is removably attached to the base insert by longitudinally aligning the locking groove of the base insert with the locking nub of the base adapter.

10. The adjustable cup holder adapter of claim 8, wherein a second insert adapter is removably attached to the first based adapter by longitudinally aligning the locking groove of the first insert adapter with the locking nub of the second base adapter, allowing the second insert adapter to securely attach to the first insert adapter.

11. The adjustable cup holder adapter of claim 1, wherein the adjustable cup holder adapter is formed of a sturdy and resistant material comprising at least one of a plastic, thermoplastic, metal, and polymer.

12. A method of attaching the insert adapter to the base insert, comprising:
longitudinally orienting the insert adapter with the base insert;
aligning the locking nub of the adapter insert with locking groove of the base insert;
sliding the locking nub along the locking groove towards the opposing end of the base insert; and
twisting the insert adapter in a latitudinal fashion to guide the locking nub into the locking notch of the base insert.

13. A method of attaching the second insert adapter to the first insert adapter, comprising:
longitudinally orienting the second insert adapter with the first insert adapter;
aligning the locking nub of the second adapter insert with locking groove of the first adapter insert;
sliding the locking nub along the locking groove towards the opposing end of the base insert; and
twisting the second insert adapter in a latitudinal fashion to guide the locking nub into the locking notch of the first insert adapter.
